(19) United States
(12) Patent Application Publication
(10) Pub. No.: US 2004/0250218 A1
(43) Pub. Date: Dec. 9, 2004

(54) Empathetic human-machine interfaces

(75) Inventors: David B. Wecker, Redmond, WA (US); Cameron A. Eltezadi, Bellevue, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation

(21) Appl. No.: 10/456,365

(22) Filed: Jun. 6, 2003

(51) Int. Cl. G09G 5/00

(52) U.S. Cl. 715/812

(57) ABSTRACT

An empathetic interface individualizes the interaction of a user and a computer. The empathetic interface educes user intentions to move or perform actions with a pointing device without the user having to objectively communicate in an explicit manner, such as manually moving the mouse from one location to another location or performing a user interface action. The user initiates a movement or an action and the empathetic interface completes the movement or the action.

### FIELD OF THE INVENTION

The present invention relates generally to human-machine interfaces, and more particularly, to educing intentions of a user from actuations of a pointing device to navigate a pointer in a user interface.

### BACKGROUND OF THE INVENTION

A computer mouse, such as a mouse 104 shown in FIG. 1, is a common pointing device, popularized by its inclusion as standard equipment with the Apple Macintosh. The use of mice has been growing in correspondence with the rise in the use of personal computers and workstations thanks to the rise in popularity of graphical user interfaces. The basic features of a mouse include a casing with a flat bottom designed to be gripped by one hand; one or more buttons on the top; a multi-directional detection device (usually a ball or a laser) on the bottom; and a cable connecting the mouse to a computer, such as a computer 102. By moving the mouse on a surface (such as a desk), a user typically controls an on-screen pointer. To select items or choose commands on the screen, the user presses one of the mouse's buttons, producing a “mouse click.”

Effective interfacing with computers has always been difficult for users, which in part is due to the dearth of intuitive ways to communicate with computers. The mouse 104 has become ubiquitous in part because it allows a user better control over the computer 102. Whereas the combination of a key board and a command-line interface rigidly and linearly restrains the means by which the user interacts with the computer 102, the combination of the mouse 104 and a pointer affords unfettered freedom of movement for the user to explore the user interface. One reason for this is because the mouse 104 is a relative pointing device for which there are no pre-defined limits to the mouse's movement and because its placement on a surface does not map directly to a specific screen location. This adds to the user's illusion of intuition and control over the computer 102. With this illusion comes the reality of toilsome effort for the user to navigate the mouse 104 over an ever expanding and increasingly cluttered computer screen (not shown), which is filled with a bewildering array of user interface objects for pointing, clicking, dragging, and dropping.

Efforts have been made, in both hardware and software, to improve the mouse 104 and the interactions with the computer 102 using the mouse 104. Hardware improvements to the original one-button design have included physical changes to the mouse 104 to incorporate the addition of extra buttons (left, right, middle, side), and wheels.

Related software improvements include drop-down menus that are automatically shortened to show only those menu items that are frequently accessed by the user. This is an unexpected interface behavior from the user's perspective, however, because menu items disappear in disregard to the intention of the user. Another software improvement includes the ability for the user to make simple gestures with the mouse to evoke certain functionalities, such as editing a typed word in a word processing application. The problem with this is that the user is forced to learn an exotic set of gestures, which without regular usage may be forgotten. A further improvement in software includes context menus which appear when a correct combination of mouse buttons are depressed. The problem with a context menu is that its menu item choices are both limited and predetermined, potentially neglecting the intentions and needs of the user. These software improvements, while significant in improving human-machine interaction, nonetheless never make the interfaces get better at working with users. The reason is because these interfaces wrongfully assume that all users are the same and dictate how all users should interact with computers. This problem is illustrated in further detail by a system 100 shown in FIG. 1.

The system 100 includes the personal computer 102, which is a computer designed for use by one person at a time. Personal computers do not need to share the processing, disk, and printer resources of another computer. IBM PC-compatible computers and Apple Macintoshes are both examples of personal computers. If the personal computer 102 employs a graphical user interface, the mouse 104 coupled to the personal computer 102 can be used to navigate a pointer in the graphical user interface and applications running on such a graphical user interface.

One application example is application 106, which is a program designed to assist in the performance of a specific computing task, such as word processing, accounting, or inventory management. As is typical with most applications, the application 106 includes a menu bar 108 which contains various menus, such as a file menu 110, an edit menu 112, and a help menu 114. Each menu, when selected, drops from the menu bar to reveal a list of options from which a user can make a selection in order to perform a desired action, such as choosing a command or applying a particular format to part of a document. Each menu, when selected, remains open without further action until the user closes the menu or chooses a menu item.

The application 106 includes a frame 116 in which a rectangular space defines the work area for the application 106. Various user interface elements may appear in the frame 116, such as a dialog box 118. Dialog boxes, in a graphical user interface, are special windows displayed by the operating system or application 106 to solicit a response from the user. More specifically, the dialog box 118 is a PRINT dialog box through which the user can instruct the computer to send information to a printer (not shown). The dialog box 118 has a title bar 120 showing the word “PRINT” signifying the functional significance of the dialog box 118. The dialog box 118 includes two radio buttons 122, 124, each a means of selecting one of several options. A radio button appears as a small circle that, when selected, has a smaller, filled circle inside it. Selecting one button in a set 122, 124 deselects the previously selected button, so one and only one of the options in the set 122, 124 can be selected at any given time. The radio button 122, when selected, allows all pages of a document of the application 106 to be sent to the printer for printing. If a more limited page selection is desired, the radio button 124 is selected instead. A default button 126 (“OK”) is a control that is automatically selected when the dialog box 118 is introduced by the application 106 or the operating system. The default button 126 is typically activated by pressing the ENTER key on the keyboard. The movement of a pointer 128 is controlled by the user via the mouse 104. As discussed above, the pointer 128 is an on-screen symbol, such as an arrowhead leaning slightly leftward or rightward, that can be controlled by the mouse 104 or other input devices and is used as a means of indicating (and selecting) locations or choices on the screen.

An additional improvement in mouse interface software is the “snap-to” feature, which automatically places the pointer 128 over the default button 126 of the dialog box 118. In other words, when the “snap-to” feature is turned on, the pointer 128, without any prompting by the user, jumps from its location (and a location at which the user has established an orientation) to the center of the default button 126, wherever that may be. While some users have found the “snap-to” feature useful, others have found it disorienting. The reason that this feature, as well as all the other features discussed above, confuses users is because the feature does not know or care about the user's intentions. All of these features are pre-programmed and predetermined to act without any prompting from users.

A mouse is something a user would expect to move himself, thereby moving a pointer 128 in correspondence with the movement of the mouse 104. By causing the pointer 128 to be moved without any movement of the mouse 104 creates cognitive dissonance for the user because it is an unexpected behavior and therefore seems unnatural. For example, users do not expect the keyboard to begin typing without any prompting from the user. In contrast, certain behaviors like displaying a window on a screen automatically by the personal computer 102 are acceptable, but automatic movement of the mouse causes the user to lose a sense of place and displaces the user's bearings from his normal interaction with the computer 102.

Uniformity in user interfaces have enabled all users to know how to choose commands, start programs, and see lists of files and other options by pointing to pictorial representations (icons) and lists of menu items on the screen. All users know that choices can generally be activated either with the keyboard or with a mouse. For application developers, uniformity in user interfaces offers an environment that processes directly users' interaction with the computer no matter who each user may be. This frees the developer to concentrate on the application without worrying about the details of screen display, mouse control, or keyboard input. It also provides programmers standard controlling mechanisms for frequently repeated tasks such as opening windows and dialog boxes.

Uniformity helps increase standardization of the personal computer and enables all users to share similar computing experiences, such as using the mouse. However, the emphasis has been more on the “computer” and much less on the “personal.” Computers have gotten more complicated, screen sizes have increased, and user interface choices have proliferated. To overcome these problems, choices are premade for users to alleviate the Byzantine complexity that can result but these choices are made in the absence of knowledge of users' intentions. Without a solution to focus on the personal computing experience and help each user better navigate a user interface using a pointing device, such as a mouse, users may eventually no longer trust the system 100 to provide a desired computing experience, causing demand for the system 100 to diminish from the marketplace. Thus, there is a need for a method and a system for educing intentions of a user to navigate a pointer in a user interface while avoiding or reducing the foregoing and other problems associated with existing user interface features.

### SUMMARY OF THE INVENTION

In accordance with this invention, a system, method, and computer-readable medium for educing user intentions is provided. The term “educing” refers to an act of bringing out the intentions of the user, which is latent in his usage of a pointing device. The term “empathetic” means the ability of the human-machine interface to understand, aware of, and sensitive to so as to educe the intentions of the user based on either past or present input device usage experience without having the intentions fully communicated in an objectively, explicit manner (e.g., mere movement of the mouse will suffice).

The system form of the invention includes a computer system for educing user intentions. The computer system comprises an on-screen cursor for performing user interface actions in a user interface. The on-screen cursor is controlled by a pointing device. The computer system also comprises an empathetic interface for educing a user intention to move the on-screen cursor from a first location to a target location in the user interface and moving the on-screen cursor to the target location from the first location when the user initiates actuation of the pointing device to cause the on-screen cursor to begin to move toward the target location.

Another system form of the invention includes a computer system for building an empathetic interface to educe user intentions to navigate an on-screen cursor in a user interface. The computer system comprises a model builder adapted for receiving events generated by a pointing device when the user navigates the on-screen cursor toward a user interface target to perform an action. The model builder is further adapted for receiving model parameters. The computer system further comprises a model for empathetically educing a user's intention to navigate the on-screen cursor toward the user interface target to perform the action. The model is built by the model builder in accordance with the received events and the model parameters.

A computer-readable form of the invention includes a data structure stored thereon for use by a computing system to educe user intentions. The data structure comprises a header field that is indicative of a screen resolution and a screen origin. The data structure further comprises a data field that is indicative of a start event, a move event, and a termination event of a pointing device being actuated by a user in navigating an on-screen cursor in a user interface.

An additional system form of the invention includes a computer system for educing user intentions. The computer system comprises an operating system that controls the usage of resources in the computer system. The computer system further comprises an empathetic interface coupled to the operating system for educing user's intention to move an on-screen cursor from a first location to a target location in a user interface to perform an action and moving the on-screen cursor to the target location from the first location to perform the action when the user initiates actuation of a pointing device to cause the on-screen cursor to begin to move toward the target location.

A method form of the invention includes a method implemented in a computer system for educing a user's intention to navigating a pointer in a user interface. The method comprises inputting a set of Cartesian coordinates indicative of a first location of the pointer when the user initiates the actuation of a pointing device toward a target location. The act of inputting includes inputting a velocity of the actuation into a model. The method further comprises empathetically educing the target location including an action to be taken by the pointer when the pointer has been moved by the method to the target location.

Another method form of the invention includes a method implementable in a computer system for building an empathetic interface that educes user intentions for navigating a pointer. The method comprises accumulating data relating to a pointing device and building a model for educing user intentions using the accumulated data. The method further comprises educing user's intention to navigate the pointer from a first location of the pointer to perform an action at a target location when the user initiates the actuation of a pointing device toward the target location. The method additionally comprises retraining the model if the model is not sufficiently accurate.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrating a conventional system showing the “snap-to” feature, which automatically moves a pointer to a default button in disregard to a user's intention;

FIG. 2 is a block diagram illustrating an exemplary computing device;

FIG. 3 is a block diagram illustrating the movement of the pointer to a desired location in a user interface by educing user intentions through the motion nuances of a pointing device, such as a mouse, according to one embodiment of the present invention;

FIG. 4A is a block diagram illustrating pieces of a system for educing user intentions through the motion nuances of a pointing device, such as a mouse, for navigating a pointer in a user interface, according to one embodiment of the present invention;

FIG. 4B is a block diagram illustrating pieces of a mouse information gatherer, according to one embodiment of the present invention;

FIG. 4C is a structured diagram illustrating a stream file in which the relationship among multiple data fields is described, according to one embodiment of the present invention;

FIG. 4D is a block diagram illustrating an aggregator for aggregating stream files into a database, according to one embodiment of the present invention;

FIG. 4E is a structured diagram illustrating portions of a database, and more particularly, a data structure where data samples of a mouse are stored, according to one embodiment of the present invention;

FIG. 4F is a block diagram illustrating the formation of a model from the data samples illustrated in FIG. 4E, according to one embodiment of the present invention;

FIG. 4G is a structured diagram illustrating portions of a database, and more particularly, a data structure where data samples of the movement of a pointing device, such as a mouse, are stored, according to one embodiment of the present invention;

FIG. 4H is a block diagram illustrating the formation of a model using data samples illustrated in FIG. 4G, according to one embodiment of the present invention; and

FIGS. 5A-5H are process diagrams illustrating a method for educing user's intention to navigate a pointer in a user interface, according to one embodiment of the present invention.

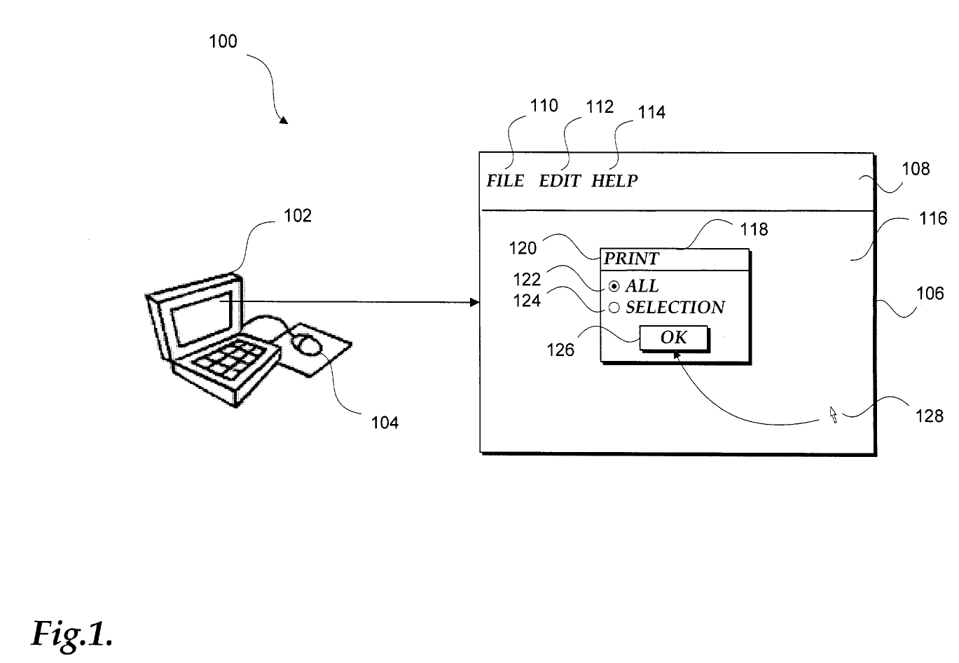

### DETAILED DESCRIPTION OF THE PREFERRED EMBODIMENT

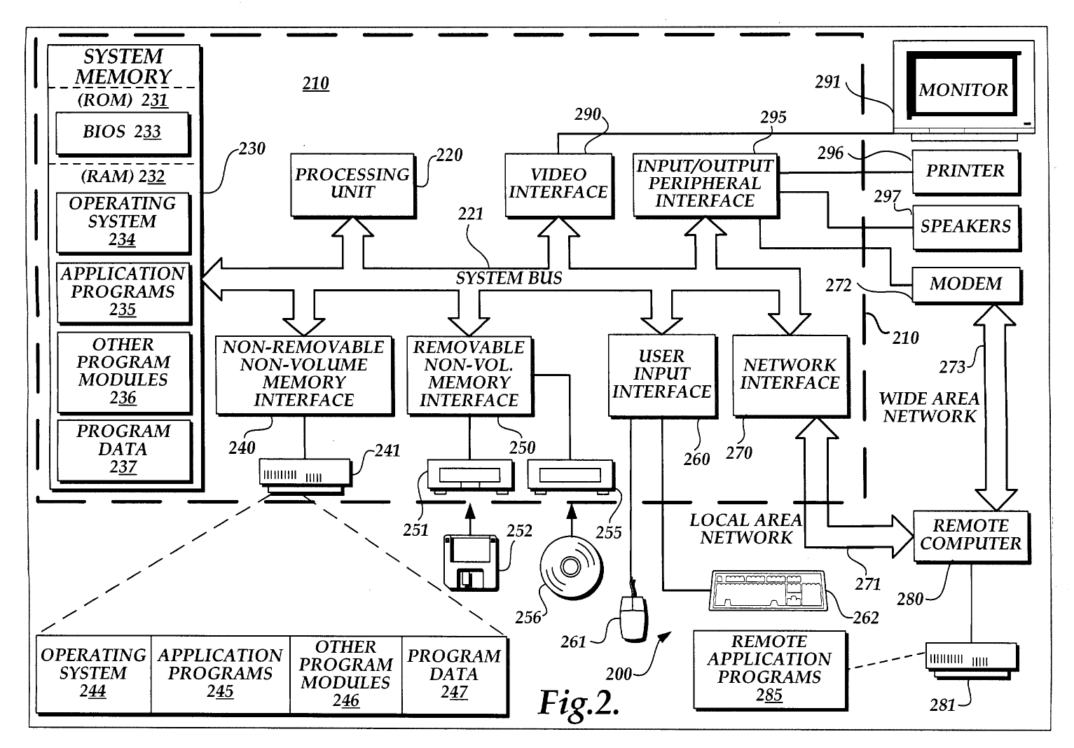

FIG. 2 illustrates an example of a computing system environment 200 suitable for practicing certain aspects of the invention, such as the manufacturing of an empathetic interface that captures a user's usage of a pointing device, such as a mouse, and educes the user's intentions to navigate a corresponding on-screen pointer in a user interface via the empathetic interface. The computing system environment 200 is only one example of a suitable computing environment and is not intended to suggest any limitation as to the scope of use or functionality of the invention. Neither should the computing environment 200 be interpreted as having any dependency or requirement relating to any one or a combination of the illustrated described components.

The invention is operational with numerous other general purpose or special purpose computing system environments or configurations. Examples of well-known computing systems, environments and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention is described in the general context of computer-executable instructions, such as program modules being executed by a computer. Generally, program modules include routines, programs, objects, components, data structures, etc. that perform particular tasks or implement particular abstract data types.

The invention may also be practiced in distributed computing environments where tasks are performed by remote processing devices that are linked through a communications network. In a distributed computing environment, program modules may be located in both local and remote computer storage media, including memory storage devices.

The computing system environment illustrated in FIG. 2 includes a general purpose computing device in the form of a computer 210. Components of computer 210 may include, but are not limited to, a processing unit 220, a system memory 230, and a system bus 221 that couples various system components including the system memory to the processing unit 220. The system bus 221 may be any of several types of bus structures, including a memory bus or memory controller, a peripheral bus, and a local bus using any of a variety of bus architectures. By way of example, and not limitation, such bus architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

Computer 210 typically includes a variety of computer-readable media. Computer-readable media can be any available media that can be accessed by computer 210 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data. Computer storage media include, but are not limited to, RAM, ROM, EEPROM, flash memory or other memory technology, CD-ROM, digital versatile disks (DVD) or other optical disk storage, magnetic cassettes, magnetic tapes, magnetic disk storage or other magnetic storage devices, or any other computer storage media. Communication media typically embody computer-readable instructions, data structures, program modules or other data in a modulated data signal, such as a carrier wave or other transport mechanism that includes any information delivery media. The term “modulated data signal” means a signal that has one or more of its characteristics set or changed in such a manner as to encode information in the signal. By way of example, and not limitation, communication media include wired media, such as a wired network or direct-wired connection, and wireless media, such as acoustic, RF infrared, and other wireless media. A combination of any of the above should also be included within the scope of computer-readable media.

The system memory 230 includes computer storage media in the form of volatile and/or nonvolatile memory, such as read only memory (ROM) 231 and random access memory (RAM) 232. A basic input/output system 233 (BIOS), containing the basic routines that help to transfer information between elements within computer 210, such as during start-up, is typically stored in ROM 231. RAM 232 typically contains data and/or program modules that are immediately accessible and/or presently being operated on by processing unit 220. By way of example, and not limitation, FIG. 2 illustrates operating system 234, application programs 235, other program modules 236, and program data 237.

The computer 210 may also include other removable/non-removable, volatile/nonvolatile computer storage media. By way of example only, FIG. 2 illustrates the hard disk drive 241 that reads from or writes to non-removable, nonvolatile magnetic media, the magnetic disk drive 251 that reads from or writes to a removable, nonvolatile magnetic disk 252, and an optical disk drive 255 that reads from or writes to a removable, nonvolatile optical disk 256, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital videotapes, solid state RAM, solid state ROM, and the like. The hard disk drive 241 is typically connected to the system bus 221 through a non-removable memory interface, such as interface 240, and the magnetic disk drive 251 and optical disk drive 255 are typically connected to the system bus 221 by a removable memory interface, such as interface 250.

The drives and their associated computer storage media discussed above and illustrated in FIG. 2 provide storage of computer-readable instructions, data structures, program modules and other data for the computer 210. In FIG. 2, for example, hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 210 through input devices, such as a keyboard 262 and pointing device 261, the latter of which is commonly referred to as a mouse, trackball, or touch pad. Other input devices (not shown) may include a microphone, joystick, game pad, satellite dish, scanner, or the like. These and other input devices are often connected to the processing unit 220 through a user input interface 260 that is coupled to the system bus, but may be connected by other interface and bus structures, such as a parallel port, game port, or universal serial bus (USB). A monitor 291 or other type of display device is also connected to the system bus 221 via an interface, such as a video interface 290. In addition to the monitor, computers may also include other peripheral output devices, such as speakers 297 and printer 296, which may be connected through an input/output peripheral interface 295.

The computer 210 may operate in a networked environment using logical connections to one or more remote computers, such as a remote computer 280. The remote computer 280 may be a personal computer, a server, a router, a network PC, a peer device, or other common network node, and typically includes many or all of the elements described above relative to the computer 210, although only a memory storage device 281 has been illustrated in FIG. 2. The logical connections depicted in FIG. 2 include a local area network (LAN) 271 and a wide area network (WAN) 273, but may also include other networks. Such network environments are commonplace in offices, enterprise-wide computer networks, intranets, and the Internet.

When used in a LAN networking environment, the computer 210 is connected to the LAN 271 through a network interface or adapter 270. When used in a WAN networking environment, the computer 210 typically includes a modem 272 or other means for establishing communications over the WAN 273, such as the Internet. The modem 272, which may be internal or external, may be connected to the system bus 221 via the input/output peripheral interface 295, or other appropriate mechanism. In a networked environment, program modules depicted relative to the computer 210, or portions thereof, may be stored in the remote memory storage device. By way of example, and not limitation, FIG. 2 illustrates remote application programs 285 as residing on memory device 281. It will be appreciated that the network connections shown are for illustrative purposes only and other means of establishing a communication link between the computers may be used.

Present personal computers are not truly “personal” because these computers do not know who their users are. Various embodiments of the present invention provide an empathetic human-machine interface (hereinafter “empathetic interface”) that learns about its user and can educe the intention of its user so as to aid the user to move a pointer actuated by a pointing device, such as a mouse.

Moving the mouse in a certain direction, at a certain speed, with a certain acceleration, among other factors, forms an intention, which can be educed by the empathetic interface. As an example, if a user were to move quickly with the mouse in a certain direction, it is likely that the user would be trying to navigate far from where the mouse pointer was located originally. Users typically do not move a mouse for no reason, and thus, given a direction, the empathetic interface can calculate a set of user interface objects that are potential targets. On the other hand, if the user were to make small, fluid mouse movements, he would likely be doing work, such as typing or drawing. By allowing users to initiate a move before the empathetic interface completes the move prevents or reduces users' disorientation. Users are not likely to be subject to cognitive displacement or losing a sense of place because they are the ones who have initiated movement of the pointer in a certain direction by actuating the mouse. Users no longer have to drag the mouse pointer all over a screen. User interface objects are easier to get to. A personal computer, whose operating system is fitted with an empathetic interface, learns who its users are, and learns the ways its users want to navigate the user interface.

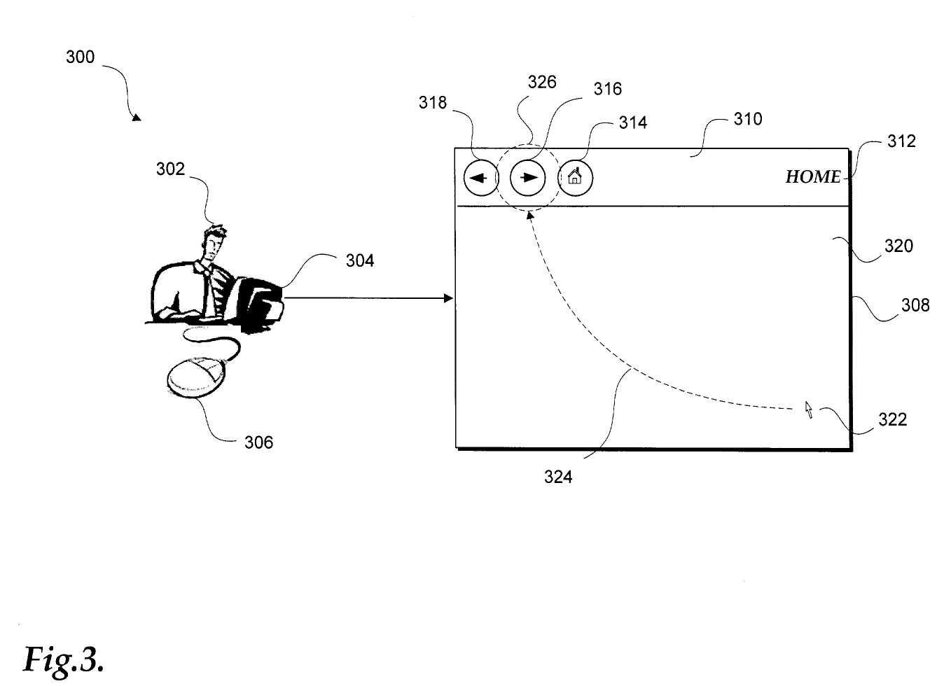

A system 300 is shown in FIG. 3 in which a pointer 322 is moved at the initiation of a user 302 to a target 326 in accordance with the intention of the user 302. The system 300 is a computing environment that has pieces of hardware, software applications, and an operating system running on it. The user 302 operates a mouse 306 to navigate the pointer 322 in a user interface on the personal computer 304. The personal computer 304 is a machine capable of repetitively and quickly performing calculations and instructions, and is designed to be used by a single person at a time. The personal computer 304 is smaller, less expensive, and easier to use than other classes of computers such as supercomputers, mainframe computers, and workstations. Personal computers, such as the personal computer 304, provide computational abilities at a low cost to people who lack extensive programming experience. The user 302 operates the personal computer 304 to interface with worldwide communication networks, such as the Internet, and the graphics-based information database, known as the World Wide Web, to find information on virtually any subject.

Among applications running on the personal computer 304 is a Web-styled application 308. The application 308, like other window applications, includes a toolbar 310, which is a horizontal space at the top of a window that contains a number of buttons in iconic form 314-318 to allow the user 302 to access various user interface pages of the application 308. The button 318, which appears as a left pointing arrow enclosed by a circle, allows the user 302 to move backward through a history of displayed pages. The button 316, which appears as a right-pointing arrowhead enclosed in a circle, allows the user to advance to a new page previously undisplayed. The button,314 is a home button that appears as a simple house enclosed in a circle, which returns the user 302 to a home page when clicked upon. Appearing in the right corner of the toolbar 310 is the name 312 of the page, which in this instance is “HOME”.

A frame 320 defines a rectangular section of the application 308, which is subjacent to the toolbar 310, and allows pages to be displayed. The user 302 performs work in the application 308 by moving an on-screen symbol, such as the pointer 322, which appears as an arrowhead leaning slightly leftward. The pointer 322 is controlled by the mouse 306 or other input devices. The pointer 322 is used as a means of indicating (and selecting) locations or choices in the application 308.

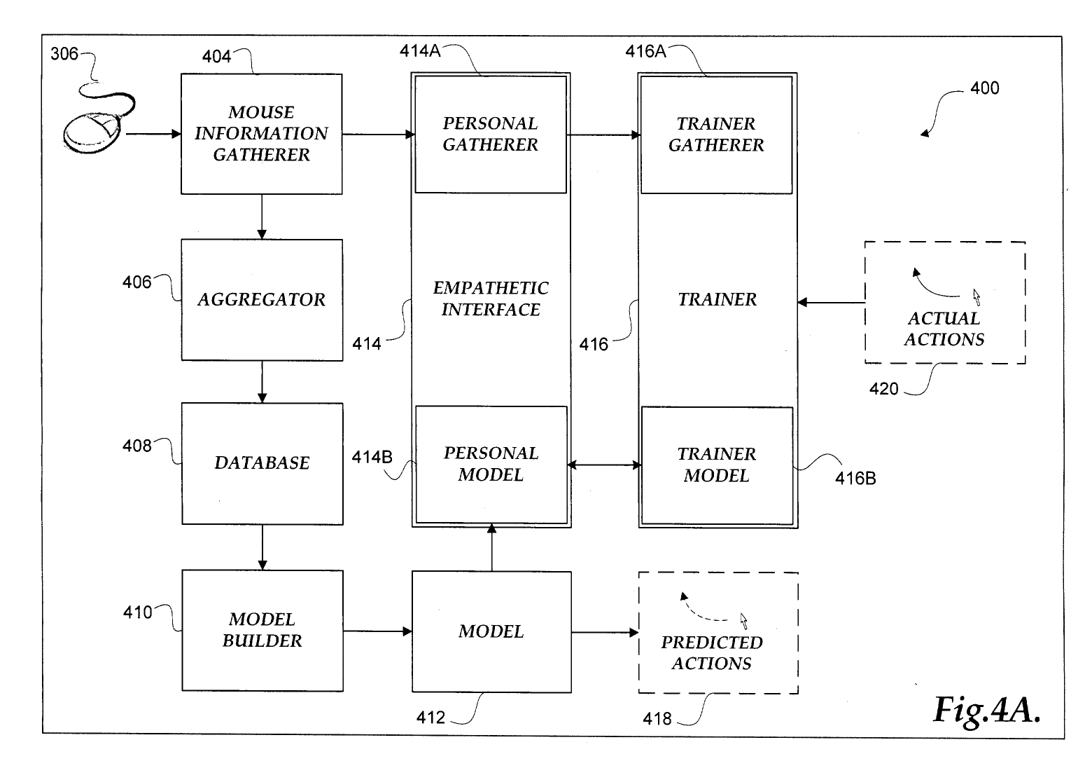

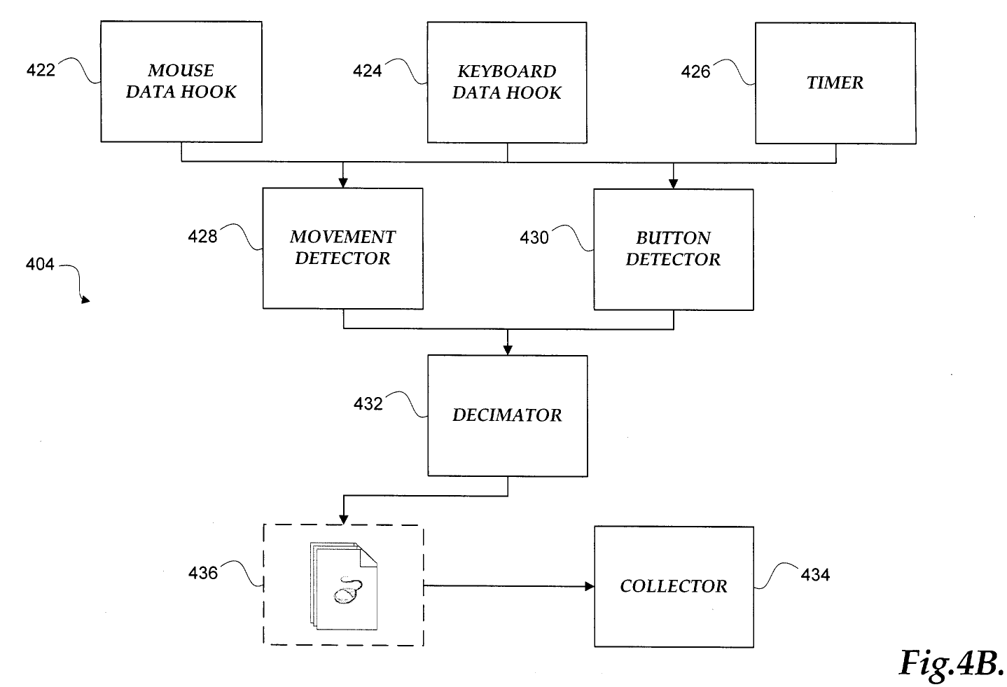

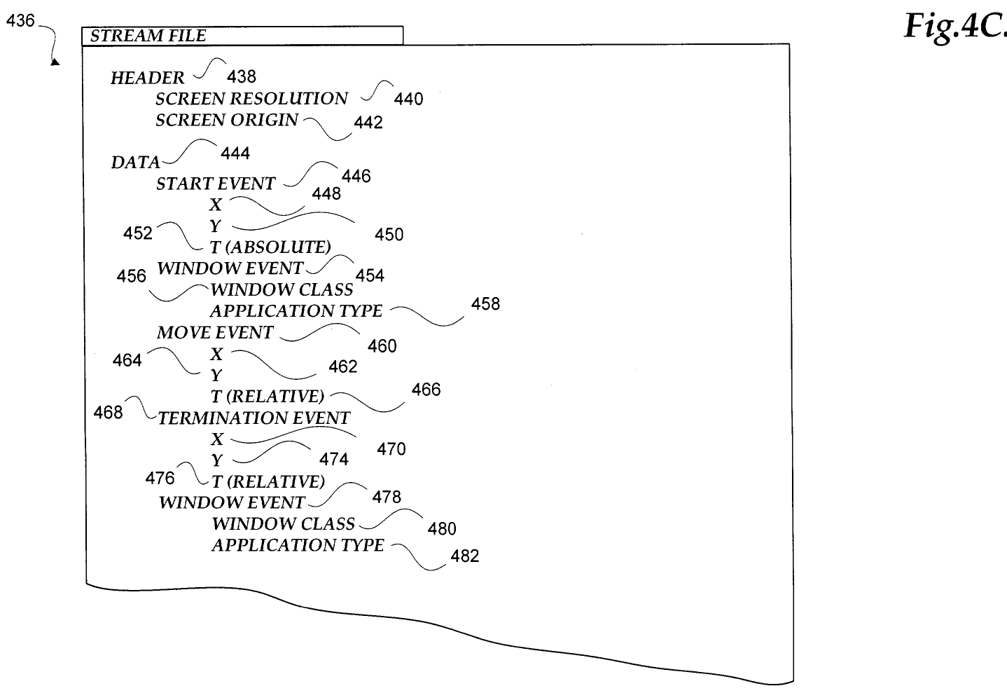

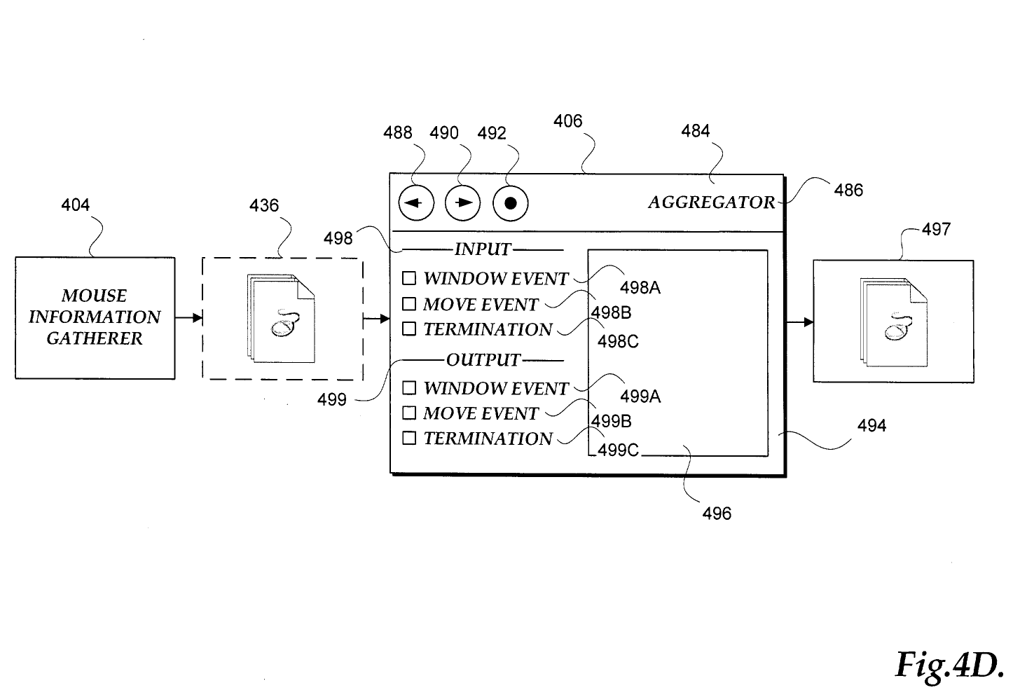

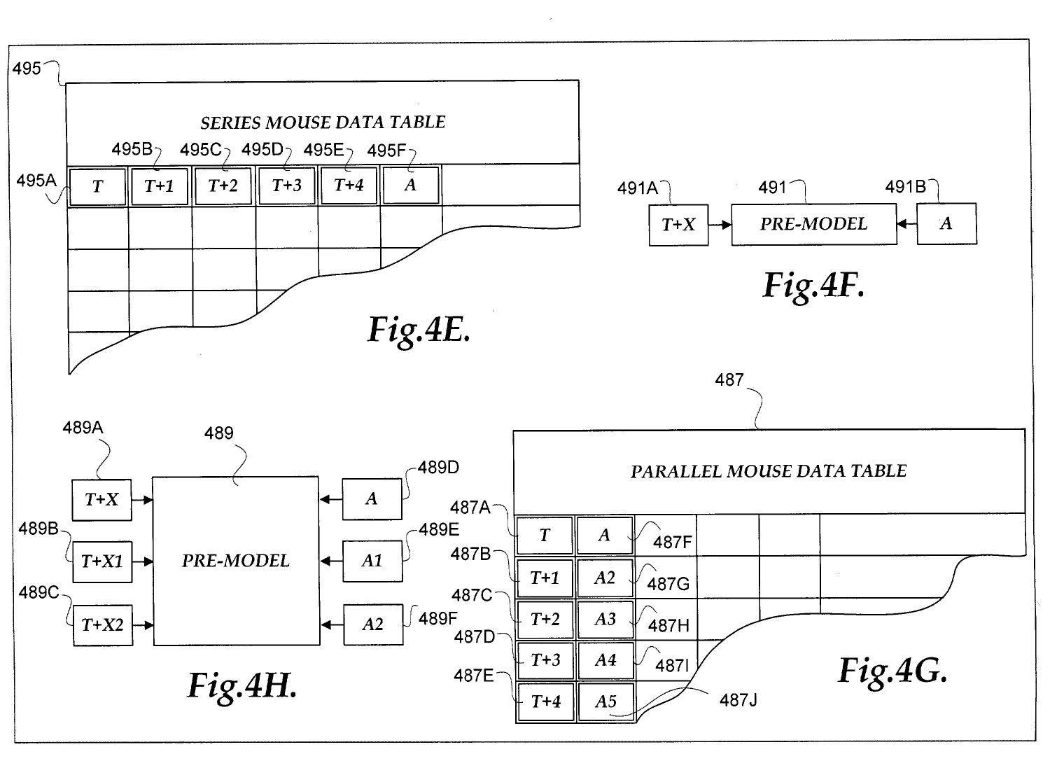

Suppose that the user 302 desires to move the pointer 322 toward the forward button 316 to select it. Various embodiments of the present invention educe the intention of the user 302 to move the pointer 322 toward the forward button 316 by the motion nuances of the mouse 306. The user 302 need only move the mouse 306 slightly for this eduction to occur. The eduction empathetically projects a trajectory course 324 originating from the current location of the pointer 322 and ending at the target 326, which is the forward button 316. This occurs without the user 302 having to fully communicate his desire to move the pointer 322 to the forward button 316 in an objectively explicit manner. The eduction is achieved by an empathetic interface 414 illustrated at FIG. 4A.

A system 400 is a group of components for building the empathetic interface 414. The empathetic interface 414 can be coupled to an operating system, which is the software that controls the allocation and usage of hardware resources such as memory, central processing unit time, disk space, peripheral devices, and user interfaces. The operating system is the foundational software upon which applications depend. The empathetic interface 414 can be designed either to always aid the user 302 in his interaction with the personal computer 304 via the mouse 306 or to function as an option that the user 302 may turn on or off depending on his preferences.

The system 400 includes a mouse information gatherer 404. Mouse information, such as the motions and button presses of the mouse 306 made by the user 302 and other users, is collected by the mouse information gatherer 404. The mouse information gatherer 404 can be placed on the personal computer 304 to monitor the use of the mouse 306 by the user 302. From the information collected by the mouse information gatherer 404, the intentions of the user 302 can be empathetically educed based on motion nuances of the mouse 306 to move the pointer 322 to a certain location in the user interface of the personal computer 304.

Exemplary information that is collected includes the location at which the user 302 begins to move the mouse 306; the location at which the user 302 ceases to move the mouse 306; whether the user 302 stayed in the same application while the mouse 306 was moved; whether the user 302 moved between window types; whether the user 302 moved to a menu, toolbars, buttons, or scroll bars, among other things; and, the actions prior to moving the mouse 306 by the user 302. For example, suppose that the user 302 is in a drawing application (not shown). The user 302 is making very small, fluid motions with the mouse 306. Suddenly, the user 302 quickly moves the mouse 306 in a fast, accelerated way toward the toolbar at which the pointer 322 ends up. The information that is generated in the hereinbefore description is collected by the mouse information gatherer 404 and allows an empathetic eduction that with the previously described combination and permutation of movements, the user 302 desires to navigate to the toolbar 310.

Information from the mouse information gatherer 404 is forwarded to the aggregator 406, which is an application that allows a developer to select pieces of information that may be of interest in the process of building the empathetic interface 414. Selected information in the form of data samples by the aggregator 406 are stored in a database 408. The database 408 is a file composed of records, each containing fields of a data structure, which is characterized by rows and columns with data samples occupying or potentially occupying each cell formed by a row-column intersection, and together with a set of operations for searching, sorting, and recombining, among other functions.

A model builder 410 extracts data samples from the database 408 to build a model 412. The model 412 contains a mapping of input data samples, such as motion information, to likely targets in the user interface by the user 302 using the mouse 306. The model 412 can be implemented using any suitable pattern recognition mechanism. One suitable pattern recognition mechanism is a neural network, which is a type of artificial intelligence system modeled after the neurons (nerve cells) in a biological nervous system and intended to simulate the way the brain processes information, learns, and remembers. A neural network is designed as an interconnected system of processing elements, each with a limited number of inputs and output. These processing elements are able to “learn” by receiving weighted inputs that, with adjustment, time, and repetition, can be made to produce appropriate outputs. Other suitable pattern recognition mechanisms are possible, including an expert system; a rule-based system; a hidden Markov model; a state machine; Bayseian analysis; and clustering techniques, among others.

It is preferred that the chosen pattern recognition mechanism can be made to run on the personal computer 304 without taxing the performance of the operating system and other applications running on the personal computer 304. The chosen pattern recognition mechanism is preferably small in size and capable of being functionally extended over time so as to adapt to the changing preferences of the user 302. Using a neural network as the pattern recognition mechanism of choice is preferred. Either a recursive neural network or a back-propagation neural network, or any other neural network, can be used as long as the chosen neural network is small and can be modified over time. The model 412 will be built and rebuilt by the model builder 410 until a reasonable accuracy of level empathetic eduction is achieved.

Once the model 412 is sufficiently accurate, the model 412 is inserted in the empathetic interface 414 as a personal model 414B. A version of the mouse information gatherer 404 is placed in the empathetic interface 414 as a personal gatherer 414A. In operation, motions and button presses by the mouse 306 are detected by the personal gatherer 414A. Such information is then empathetically educed by the personal model 414B to indicate likely locations (or actions 418) on the user interface to which the pointer 322 should be moved. The empathetic interface 414 is preferably coupled to the operating system on the personal computer 304 to aid the user 302 in navigating the pointer 322 using the mouse 306. In other words, as motion data samples are generated in real time by the mouse 306, the personal model 414B is used to figure the likely location on the user interface at which the user 302 intends to end up.

Optionally, the system 400 includes a trainer 416. The trainer 416 includes a trainer-gatherer 416A that detects mouse, button, or timer events. The trainer 416 builds an internal database from the information collected by the trainer-gatherer 416A. A trainer model 416B is a copy of the personal model 414B. During operation, the predicted actions 418 made by the personal model 414B are presented to the trainer 416. Actual actions 420 taken by the user 302 are also input into the trainer 416. If the error is too great between the predicted actions 418 and the actual actions 420, the empathetic interface 414 is turned off until the trainer 416 can retrain the personal model 414B to achieve a desired accuracy level.

The mouse information gatherer 404 comprises multiple components. See FIG. 4B. Among the components is a mouse data hook 422, which allows a developer to examine an event when the mouse 306 is actuated by the user 302. The mouse data hook 422 can be implemented as a call-back function in the operating system which is invoked whenever mouse events flow because of the actuating of the mouse 306. The collected information need not be that produced by a mouse driver on the personal computer 304. Basically, the events that are collected include movements of the mouse and button presses, such as button up or button down activities. Each movement of the mouse 306 generates at least three pieces of information (collectively “an event”): Cartesian coordinates x and y, and an absolute time at which the movement occurred (typically in hundreds of nanoseconds). Button presses produce information such as the identity of the button that was pressed (such as left, right, middle, or “X” buttons, which are buttons on the sides of the mouse 306) and the UP/DOWN state of the depressed button on the mouse 306. These pieces of button information also form an event.

Events detected by the mouse data hook 422 are presented to a movement detector 428 and a button detector 430. The movement detector 428 extracts the Cartesian coordinates x, y, and the absolute time from the information forwarded by the mouse data hook 422. The button detector 430, on the other hand, extracts the precise button that was depressed, including its state (UP or DOWN).

The mouse information gatherer 404 includes a keyboard data hook 424. The keyboard data, hook 424 receives or generates events whenever a key on the keyboard (not shown) coupled to the personal computer 304 is depressed. Keyboard events are useful to distinguish an event from a nonevent. A nonevent is defined to include movements of the mouse by the user 302 in which no further actions follow such movements. For example, f the user 302 is in a word processing application, the user 302 may want to move the pointer 322, which may appear as a text insertion symbol, out of the way so that the user 322 can type his text without being encumbered by the pointer 322. Such a movement of the pointer 322 is a nonevent.

The mouse information gatherer 404 includes a timer 426, which is a software routine used to measure time intervals. There are instances where the user 302 moves the pointer 322 via the mouse 306 but takes no subsequent actions. For example, if the application 308 is a word processing application, the user 302 may move the pointer 322 away from a line at which text is being entered by the user 302 via a keyboard. As another example, the user 302 may move the pointer 322 toward the HOME button 314, but as soon as the pointer 322 reaches the HOME button 314, the user 302 may change his mind because he is not ready to return to the HOME page from the currently displayed page of the application 308. The timer 426 allows a developer to mark a series of events that are indicative of the user 302 moving the pointer 322 to a certain location on the user interface after which no further significant actions are taken. The timer 426 encodes a time-out event, which is preferably set for a two-second duration, but any suitable length of time can be used. Thus, a time-out event is a “no op” event.

Digressing, there are at least two main classes of events. The first is a move event indicating that the pointer 322 was moved by the user 302 via the mouse 306. The second is move-termination event which is a move event followed by button events, keyboard events, or timer events, all indicating the end or termination of mouse operations. In other words, a move-termination event reflects that something purposefully has been done with the mouse 306 by the user 302 in his interaction with the user interface.

Digressing further, suppose that the user 302 moves the pointer 322 toward the target 326, which is the forward button 316, and proceeds to click it. Along the trajectory 324, the mouse 306 generates movement events, which are detected by the mouse information gatherer 404, for about every two pixels. The clicking action on one of the buttons of the mouse 306 to select the forward button 316 generates a button event. Furthermore, the movement of the pointer 322 to the toolbar 310 is a movement within the same application 308, but potentially among different window classes. In other words, the programmatic class from which the pointer 322 is moved is the frame class 320 and the target of the pointer 322 is the toolbar 310, which is represented by a toolbar class. Information like this, in the form of events, is collected by the mouse information gatherer 404 and is used later by the model builder 410 in building the model 412. These pieces of information, such as movement events and button events, grow dramatically in size as more and more information is generated by the user 302 using the mouse 306, and could be taxing to the ability of the system 400 to gather information and use the information collected for building the model 412.

Returning to FIG. 4B, both the movement detector 428 and the button detector 430 generate a large amount of events in the form of data samples from information gathered by the mouse data hook 422, the keyboard data hook 424, and the timer 426. These data samples are then presented to a decimator 432. The decimator 432 reduces the number of data samples to a lesser number from which an original or a near copy of the information from the original events can be reconstituted. In other words, the decimated stream of data samples serves as a reasonable approximation of the information in the original data stream without having to store or process the original data samples in their entirety.

Any suitable decimating algorithm can be used by the decimator 432 to reduce the amount of information in the stream of data samples being fed to the decimator 432 by the movement detector 428 and the button detector 430. One suitable decimating algorithm accounts for transient motions in the beginning when the user 302 actuates the mouse 306. In other words, once a mouse movement is detected by the movement detector 428, the decimator 432 rejects a few initial data samples to account for the user's wobble or transient motions before allowing quiescent data samples to pass.

Another suitable decimating algorithm includes controlling the domain and range of Cartesian coordinates x, y as detected by the movement detector 428. This can be useful in indicating a location at which the pointer 322 is positioned. Instead of using Cartesian coordinates x, y, polar coordinates r, θ facilitate better control over data samples that the decimator 432 allows to pass through. The decimator 432 either rejects or selects a data sample in the stream of data samples fed to the decimator 432 by the movement detector 428 and the button detector 430. Polar coordinates r, θ allow better understanding of angular directions as the pointer 322 is moved by the user 302 via the mouse 306. Polar coordinates r, θ allow calculations to be made to understand the direction toward which the pointer 322 is moving.

One threshold that can be applied by the decimator 432 in rejecting or accepting a data sample is the use of epsilon “ε.” Epsilon “ε” denotes a slight change in direction, which is signified by changes in the polar coordinates, to account for the initial wobble of the mouse 306. Data samples with changes beyond an epsilon “ε” can be classified by the decimator 432 as valid data samples and these data samples can be passed through the decimator 432.

The velocity and acceleration of the polar coordinates are (dr/dt, d²θ/dt) can be used to further qualify which data samples from the stream of data samples will be rejected or selected by the decimator 432. If the velocity value crosses beyond a velocity threshold, which is specifiable by the developer developing the model 412, the decimator 432 will allow those data samples to pass. Similarly, if the acceleration of the polar coordinate r reaches beyond an acceleration threshold, which again is determinable by the developer of the model 412, data samples will be passed by the decimator 432. Additionally, timestamps, which indicate the time it takes the user 302 to move the pointer 322 from one location to another location of data samples, are passed by the decimator 432 when the timestamps reach beyond a certain time threshold. By using the thresholds discussed above, the decimator 432 can vary the amount of information allowed to pass through from the stream of data samples.

In essence, the decimator 432 allows changed information to pass while rejecting merely cumulative information. The data samples that are allowed to be passed from the stream of data samples by the decimator 432 are placed into a suitable store. One suitable store includes memory devices (not shown) that comprise external storage such as disk drives or tape drives or internal storage such as a computer's main memory (the fast semiconductor storage (RAM) directly connected to a computing processor). Another suitable store includes one or more stream files. Each stream file, such as the stream file 436, preferably stores information in a binary format, which is encoded into a compact form. FIG. 4C illustrates a structure of the stream file 436 in greater detail.

Two major sections comprise the stream file 436. One major section is a header 438 and the other major section is a data section 444. Two pieces of information comprise the header 438: screen resolution 440 and screen origin 442. The screen resolution 440 denotes the height and width of the screen of the user interface. Regarding the screen origin 442, most screens start at Cartesian coordinates 0, 0. However, because of the usage of multiple screens by a number of users, screens may start from negative Cartesian coordinates. Cartesian coordinates 0, 0 indicates the upper left corner of a primary monitor that the user 302 is using. In cases where the user 302 has two or more screens, negative Cartesian coordinates are possible. Because of the possibility of negative Cartesian coordinates, one purpose of the header 438 is to normalize negative coordinates so that the system 400 can reference every location of a screen to Cartesian coordinates 0, 0. Normalization is also helpful for mouse information gathered from different users with different screen resolutions. For example, one user may be using a laptop with a lesser resolution than those users using another type of computer. Additionally, normalization permits the understanding of whether the pointer 322 has moved across a certain percentage of the screen, such as ten percent. Thus, the header 438 facilitates normalization across different data so that a fair comparison can be made among them.

The data section 444 includes a start event 446 that indicates the beginning of a new mouse action. Cartesian coordinates x 448, y 450 define the location of the start event 446. Absolute time t 452 is also included in the start event 446 allowing the system 400 to correlate multiple events together. Following the start event 446 is a window event 454, which includes a window class 456 and an application-type 458. The window event 454 helps the system 400 distinguish whether an event is the same or a different event. A move event is generated by the movement detector 428 and includes Cartesian coordinates x 462, y 464, and relative time t 466. The relative time t 466 denotes time increments from the absolute time t 452 of the start event 446. A termination event 468 follows the move event 460 and indicates button clicks or key presses of a keyboard, or a time-out event generated by the timer 426. Another window event 478 follows the termination event 468 and includes a window class field 480 in an application-type field 482. The window event field 478 contains information allowing the system 400 to know the location the pointer 322 is finally moved with respect to an application or a window class.

Returning to FIG. 4B, the purpose of the decimator is to determine those events not statistically significant enough such that those events do not get recorded in stream files, such as the stream file 436. In other words, if the user 302 has not moved the pointer 322 via the mouse 306 by a certain threshold, the decimator 432 will not record such data samples to the stream file 436. A wobble factor is also used by the decimator 432 to eliminate transient motions when the user 302 initially touches the mouse 306 to move the pointer 322. The wobble factor allows the decimator 432 to record only those events that are stable and not due to initial trembling or quivering in the use of the mouse 306 by the user 302.

Stream files, such as the stream file 436, are collected by a collector 434. When a stream file stored on the personal computer 304 has accumulated to a certain size, the collector 434 removes the stream file 436 from the personal computer 304 to a collection site (not shown) so that the stream file 436 does not hinder the performance of the computer 304. The collector 434 can seamlessly move the stream file 436 without the user 302 knowing about it. Each stream file typically has a unique identifier so that it can be referenced later for processing.

Returning to FIG. 4A, the mouse information gatherer 404, as discussed above, produces stream files, such as the stream file 436. Stream files are presented to the aggregator 406. The aggregator 406 allows a developer building the model 412 to pick and choose stream files that have desired data samples. Contents of selected stream files 497 are stored in the database 408. The aggregator 406 includes a toolbar 484, which is a horizontal bar containing on-screen buttons or icons 488-492, to perform certain functions of the aggregator 406. Flush to the right of the toolbar 484 is the name of the application 486, “AGGREGATOR.” Flush to the left is a button 488, which appears as a left pointing arrowhead enclosed by circle for allowing a developer to backtrack through various stream files 436 for examination. Adjacent to the button 488 is another button 490, which appears as a right pointing arrowhead enclosed in a circle for allowing the developer to sequence through the stream files in a forward fashion. Adjacent to the button 490 is a button 492, which appears as a filled circle enclosed by another circle, for allowing the developer to accept a certain stream file, such as the stream file 436, for inclusion in the database 408. The aggregator 406 includes a frame 494, which is a rectangular portion of the aggregator 406 in which further user interface elements are presented to the developer to aid the developer in the processing of choosing a stream file. A window 496 facilitates the display of the contents of a stream file for the developer's inspection.

As previously discussed, each stream file, such as the stream file 436, has a number of fields. These fields can be made to be displayed in the window 496 by selecting checkboxes 498A-498C of an input section 498. The aggregator 406 includes an output section 499 containing a number of check boxes 499A-499C, which allows the developer of the model 412 to specify termination events that he would like to see in a stream file. These termination events, if available in a stream file, will be made to display in the window 496. Input events 498A-498C and output events 499A-499C include fields in a stream file (e.g., the stream file 436, FIG. 4C). The aggregator 406 allows the developer to examine stream file by stream file using either the backward button 488 or the forward button 490. If the developer finds a desired stream file, the developer selects the select button 492 to include the contents of the stream file in the database 408.

Besides the fields 498A-498C, and 499A-499C, there are virtual fields. These virtual fields are not shown in FIG. 4D for brevity purposes. Examples of virtual fields are many: One virtual field allows the developer to select either absolute coordinates or relative coordinates; one virtual field selects either Cartesian coordinates x, y or polar coordinates r, θ; one virtual field displays the name of a window class; one virtual field indicates whether the pointer 322 terminates at a location within the same window class or in a different one; one virtual field indicates the location of the pointer 322 in Cartesian coordinates x, y or as a percentage of screen resolution with respect to the upper left corner of the screen; one virtual field indicates whether the pointer 322 starts and ends in the same application; one virtual field indicates the changes in x “Δx”, changes in y “Δy”, changes in vertical acceleration Δx², changes in horizontal acceleration Δy², changes in polar coordinates r “Δr”, changes in polar coordinate θ “Δθ”, changes in radial acceleration Δr², and changes in angular acceleration Δθ². This list is not exhaustive and others are possible.

The aggregator 406 allows the developer to select a certain set of input data and output data. These pieces of data will then be used by the model builder 410 to generate the model 412. The contents of the selected stream files 497 of the aggregator 406 are stored in the database 408 for building the model 412. The model 412 accepts input data and generates output data, which is an empathetic eduction of a likely target location of the pointer 322. For example, the input data into the model 412 may be a set of Cartesian coordinates xᵢ, yᵢ, which are indicative of the starting location of the pointer 322; the output data may include a set of Cartesian coordinates xₒ, yₒ, which are indicative of the location at which the pointer 322 is likely to end up. Other empathetic eductions include whether the pointer 322 will select the target (by clicking a mouse button) once the pointer 322 arrives at a target destination; whether the click is likely to be a left button or a right button, among other buttons; or whether a keyboard press is more likely to occur. The model 412 thus can be viewed as a black box.

Using the window 496 of the aggregator 406 allows the developer to choose the data samples to be fed into the model 412 and an action to be generated by the model 412. Each action has a number of input data samples that can be fed into the model 412. There are at least two ways to feed input and output data to the model 412. One method is to feed data samples serially to the model 412. The other method is to feed data samples in parallel. The aggregator 406 aids the developer in generating appropriate data formats for each of these two ways so that information is properly stored in the database 408.

The data samples can be fed serially into the model 412. The aggregator 406 allows the developer of the model 412 to select the serial data samples. Digressing, FIG. 4E illustrates a table 495, which is one of many tables in the database 408. The table 495 is a data structure characterized by rows and columns, with data samples occupying or potentially occupying each cell formed by a row-column intersection. An exemplary row of serial data samples 495A-495F indicates data samples that lead to an action A 495F. Using the aggregator 406, the developer of the model 412 can select data samples 495A-495E via checkboxes 498A-498C, among others, in the input section 498. To specify the action 495F, the developer would use the checkboxes 499A-499C, among others, in the output section 499 of the aggregator 406. Data samples 495A-495E can represent movements of the mouse 306 by the user 302, which culminate in an action represented by data sample A 495F.

The developer need not specify each data sample to be stored in the table 495. The aggregator 406 can generate data samples by using interpolation. For example, beginning with data sample T 495A, the developer can specify through the aggregator 406 the number of data samples and the time increments between each data sample from the data sample T 495A. Thus, by indicating five samples and time increments of 20 milliseconds, the aggregator 406 will generate data sample T+1 495B at 20 milliseconds from data sample T 495A, data sample T+2 495C at 40 milliseconds from data sample T 495A, data sample T+3 495D at 60 milliseconds from data sample T 495A, and data sample T+4 495E at 100 milliseconds from data sample T 495A.

FIG. 4F illustrates a pre-model 491 which can be formed into the model 412. Input data sample T+X 491A represents any one of the data samples 495A-495E of FIG. 4E. Output data sample A 491B is also fed into the pre-model 491, and represents the data sample A 495F of FIG. 4E.

Another technique to train the model 412 is the use of parallel data samples, as illustrated in FIG. 4G. A table 487 is one among many tables in the database 408. The table 487, whose contents are generated by the aggregator 406, is a data structure characterized by rows and columns, with data samples occupying or potentially occupying each cell formed by a row-column intersection. Two columns and five rows of data samples are shown with the table 487. Data samples 487A-487E are input data samples whereas data samples 487F-487J are output data samples. These parallel data samples are fed in parallel to a pre-model 489. See FIG. 4H. Input data samples T+X 489A, T+X1 489B, and T+X2 489C represent input data samples 487A-487E of table 487. Output data samples A 489D, A1 489E, and A2 489F represent output data samples 487F-487J of the table 487. These parallel input data samples are fed into the pre-model 489, which eventually will form the model 412. The pre-model 489 is trained to empathetically educe, as soon as possible, an action 489D-489F with the given input data samples 489A-489C. Once sufficient information is fed into the pre-model 489, the pre-model 489 can educe a predicted action. Not shown in FIG. 4G is a flag stored in the table 487 to signify the end of one set of data samples and the beginning of a new set of data samples.

Any suitable pattern recognition technique can be used to train the pre-model 491. One such suitable technique is a recursive neural network training technique. Similarly, any suitable pattern recognition technique can be used to train the pre-model 489, such as the back propagation neural network training technique. The pre-model 491 can be trained on a large number of data samples. The pre-model 491, when it has matured into the model 412, is typically small in size. The pre-model 489, on the other hand, is easier to train because it takes data samples in parallel, hence it can be trained faster. Another technique is to refrain from the use of the aggregator 406 for interpolating data samples. Instead, the developer feeds the raw information from stream files 436 directly into the database 408 to train the model 412.

Returning to FIG. 4A, the model builder 410 takes data samples from the database 408 to build the model 412. If the model 412 is a neural network, any suitable neural network builder can be used. In such a case, the model builder 410 accepts model parameters, such as the number of neural network layers; the type of neural network; and the connections with which the layers are to be coupled together. These parameters influence the model builder 410 in regard to how to use the data samples in the database 408. When the model builder 410 has processed both the parameters and the data samples in the database 408, the model 412 is produced. If the model 412 is a neural network, the model 412 is in the form of a file containing a set of floating point numbers, which represent weights of nodes in a neural network. To ascertain the accuracy of the empathetic eduction of the model 412, the model builder 410 can use statistical measurements, such as an error index or a root means square error. Thus, before the model 412 is incorporated into the empathetic interface 414, a check can be made to determine whether the model 412 should be rebuilt again to obtain better accuracy in the production of predicted actions.

Among the inputs into the model 412 or the personal model 414B for it to perform empathetic eduction are the Cartesian coordinates x, y, indicating a location of the pointer 322; changes in the Cartesian coordinates Δx, Δy; changes in vertical and horizontal acceleration, Δx², Δy²; the size of the screen x_{screen}, y_{screen}; and velocity and acceleration.

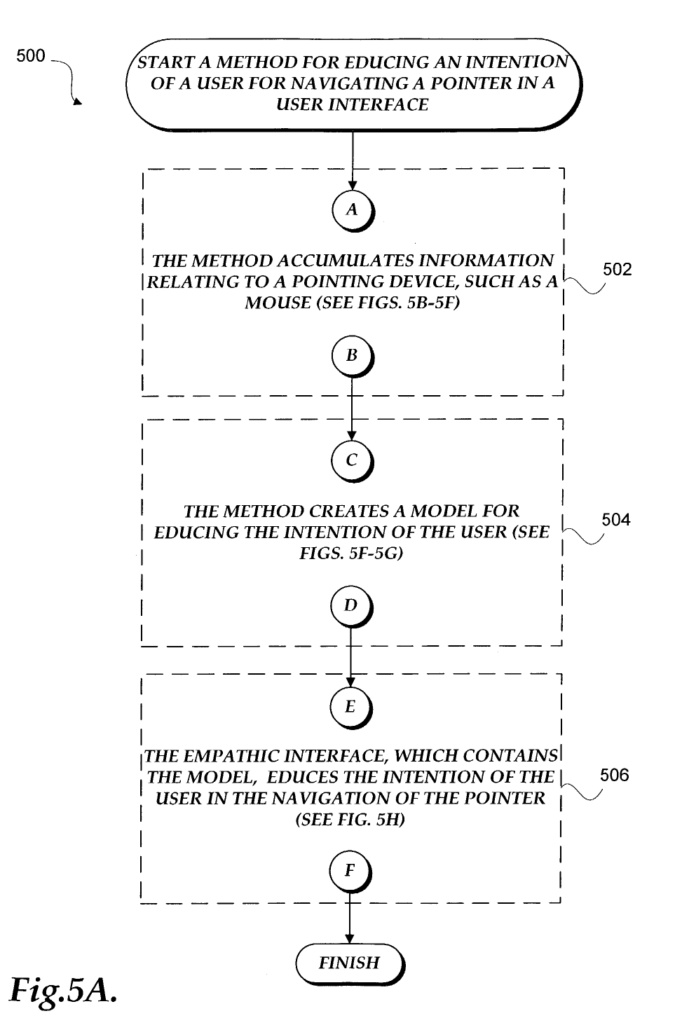

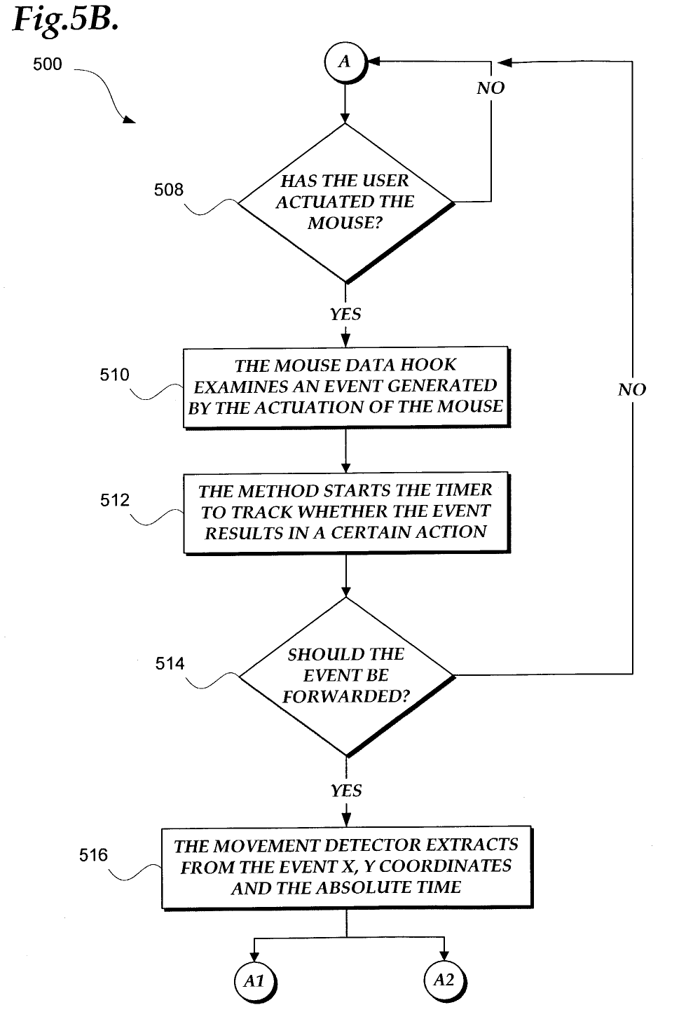

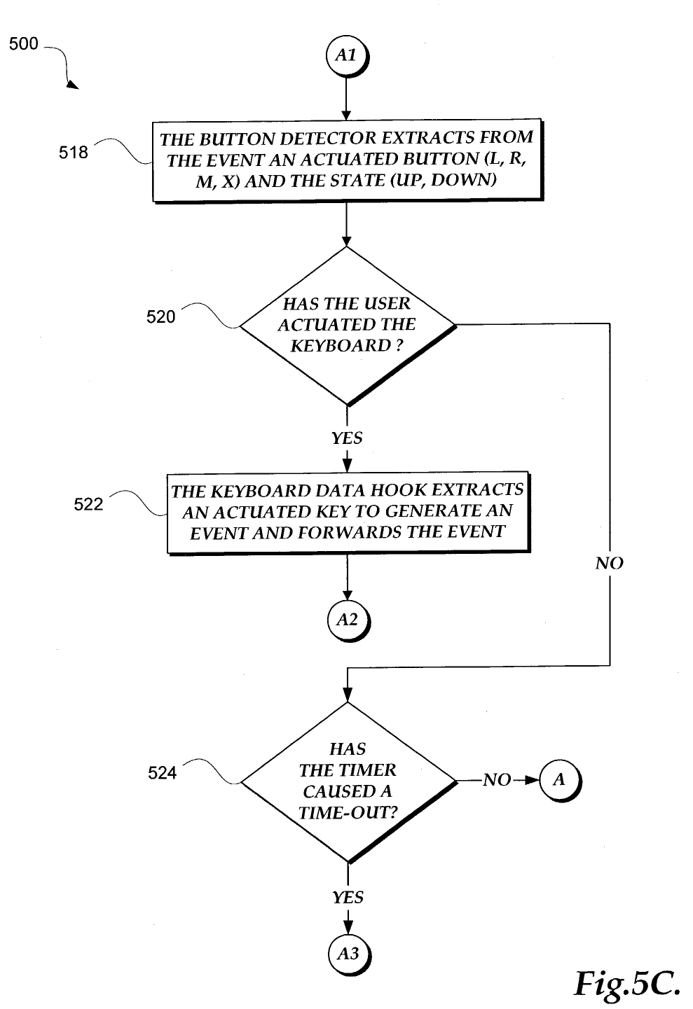

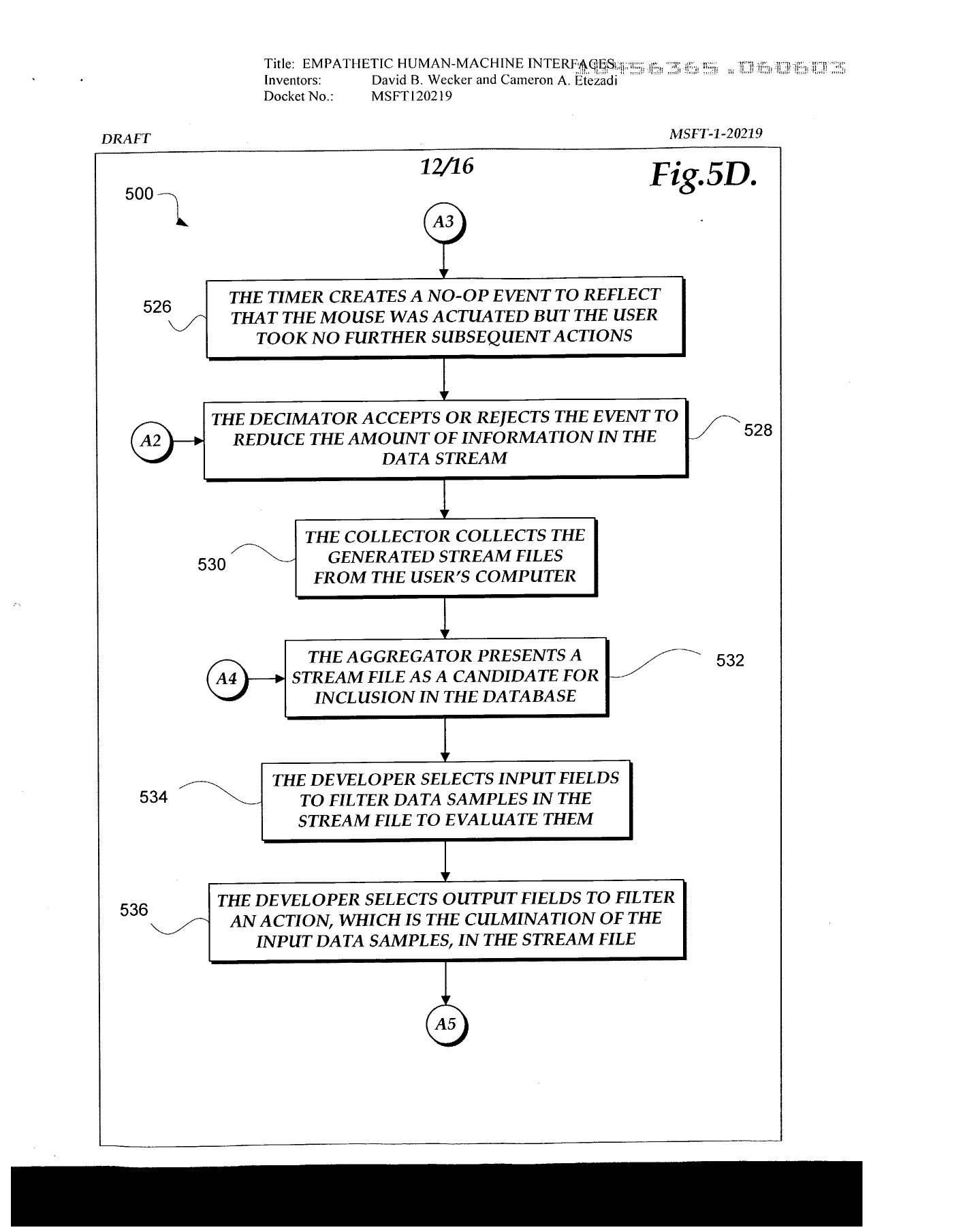

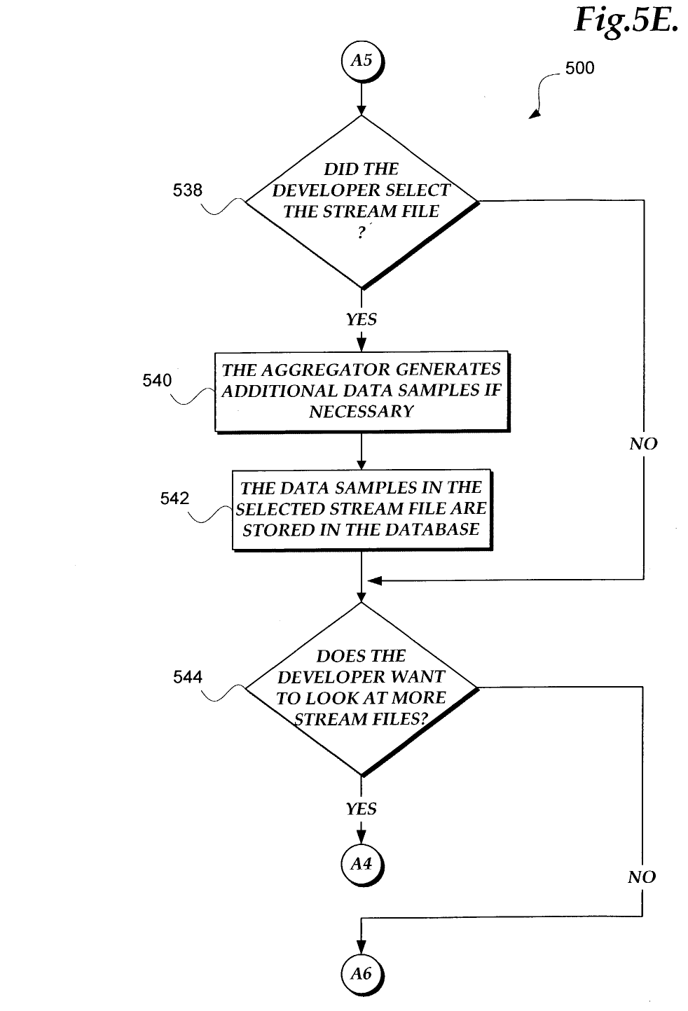

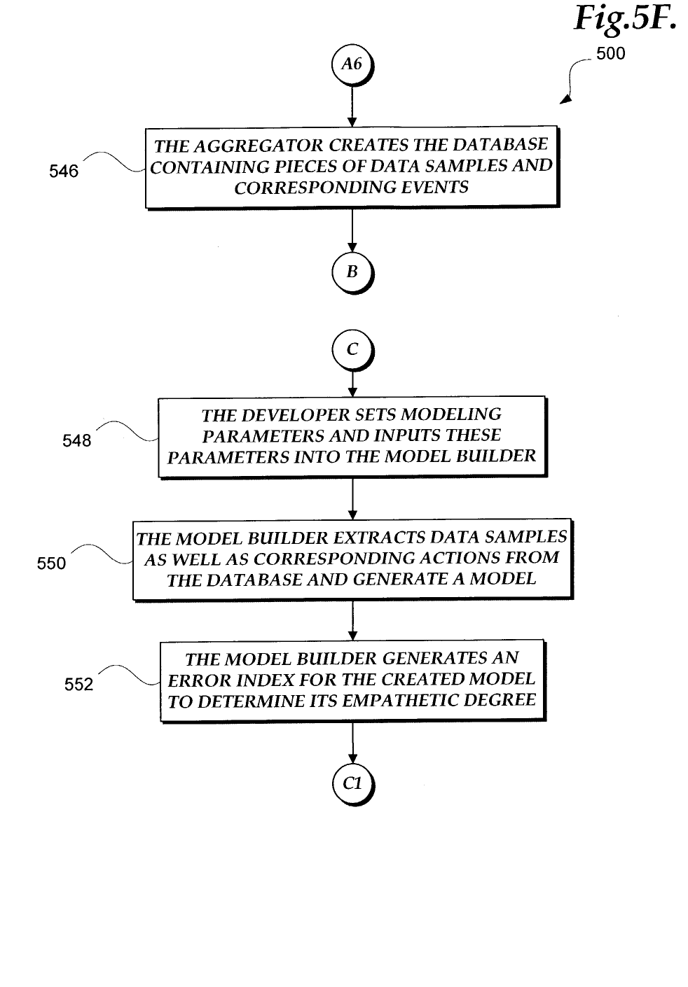

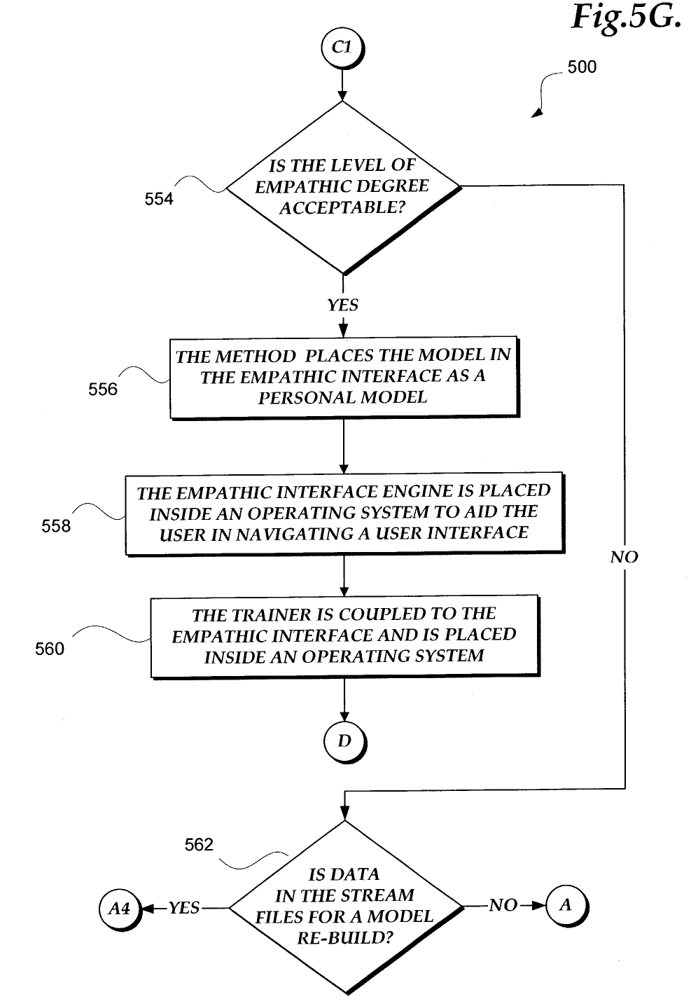

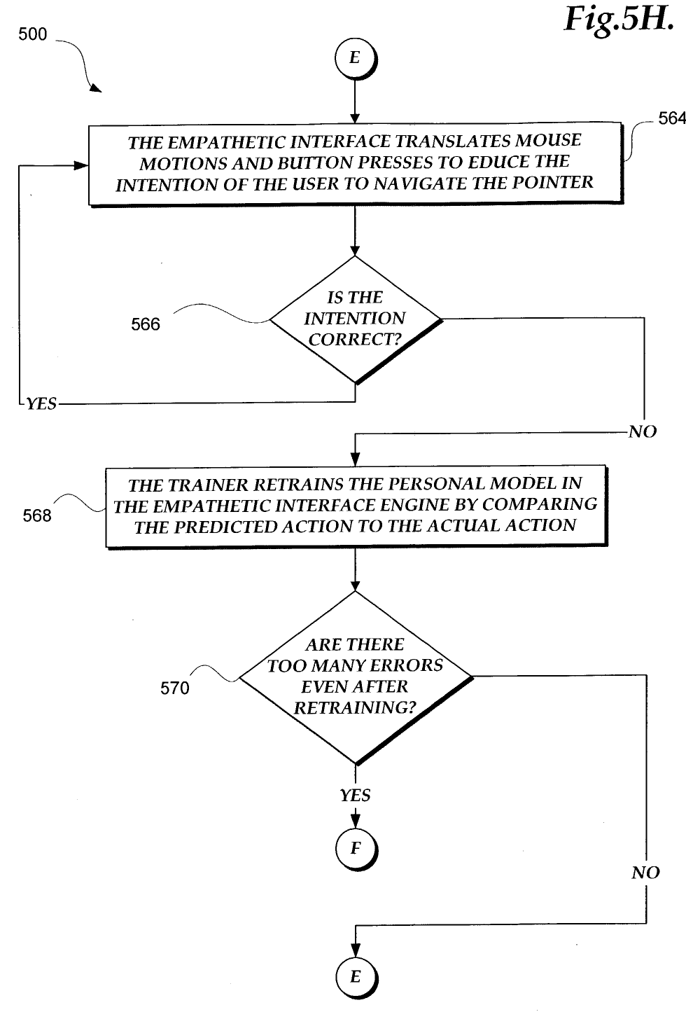

FIGS. 5A-5H illustrate a method 500 for empathetically understanding a user's intention for navigating a pointer in a user interface. For clarity purposes, the following description of the method 500 makes references to various elements illustrated in connection with the system 300 (FIG. 3), the system 400 (FIG. 4A), the mouse information gatherer 404 (FIG. 4B), the stream file 436 (FIG. 4C), the aggregator 406 (FIG. 4D), and tables of the database 408 (FIG. 4E, FIG. 4G). From a start block, the method 500 proceeds to a set of method steps 502, defined between a continuation terminal (“terminal A”) and an exit terminal (“terminal B”). The set of method steps 502 describes the process of accumulating information relating to a pointing device, such as the mouse 306.

From terminal A (FIG. 5B), the method 500 proceeds to decision block 508 where a test is made to check whether the user 302 has actuated the mouse 306. If the answer to the test is NO, the method 500 loops back to terminal A where the test at decision block 508 is made again. Otherwise, the answer is YES, and the method 500 proceeds to block 510 where the mouse data hook 422 examines an event generated by the actuation of the mouse 306. The method 500 also starts the timer 426 to track whether the generated mouse event will result in a certain action. See block 512. Next, another decision block is entered where a test is made to ascertain whether the generated event should be forwarded. Not all events generated by the mouse will be processed by the system 400. If the answer to the test at decision block 514 is NO, the method 500 loops back to terminal A. Otherwise, the answer is YES, and the movement detector 428 extracts from the forwarded event Cartesian coordinates x, y, and the absolute time. The method 500 then proceeds to exit terminals (“terminal A1” and “terminal A2”).

From terminal Al (FIG. 5C), the method 500 proceeds to block 518 where the button detector 430 extracts from the event an actuated button (left, right, middle, “X”) and the button state (up, down). Next, it is determined whether the user 302 has actuated the keyboard coupled to the personal computer 304. See decision block 520. If the answer is YES, the keyboard data hook 424 extracts an actuated key to generate an event and forwards the event to the button detector 430. See block 522. From here, the method 500 enters terminal A2. If the answer to the test at decision block 520 is NO, another decision block 524 is entered where a test is made to determine whether the timer 426 has caused a time-out. If the answer is NO, the method 500 loops back to terminal A. A time-out event indicates that the user 302 has merely moved the mouse 306, but no further actions were taken by the user 302. If the answer to the test at decision block 524 is YES, another continuation terminal is entered by the method 500 (“terminal A3”).

From terminal A3 (FIG. 5D), the method 500 proceeds to block 526 where the timer 426 creates a no-op event to reflect that the mouse 306 was actuated but the user 302 took no further actions. The method 500 then proceeds to block 528. Logic flow of the method 500 from terminal A2 also reaches block 528. At block 528, the decimator 432 accepts or rejects the data samples comprising the event so as to reduce the amount of information in the stream of data samples fed into the decimator 432, which has to be processed later by the system 400. Stream files, such as the stream file 436, are produced from the decimator 432, and the collector 434 collects the generated stream files from the user 302's computer. See block 530.

The method 500 then proceeds to block 532 where the aggregator 406 displays a candidate stream file, whose contents if selected may be included in the database 408, for the developer to examine. The developer of the model 412 selects input fields displayed by the aggregator 406 to filter data samples in the stream file so as to evaluate them. See block 534. The developer also selects output fields to filter actions, which are the culmination of the input data samples, in the stream file. See block 536. In essence, the aggregator 406 allows input data samples and actions following the data samples, which can represent movements of the mouse 306, so that these pieces of data can be stored in the database 408 for training the model 412. Next, the method 500 proceeds to another continuation terminal (“terminal A5”).

From terminal A5 (FIG. 5E), the method 500 proceeds to decision block 538 where a test is made to determine whether the developer selects the stream file by clicking on the select button 492 of the aggregator 406. If the answer is YES, the aggregator 406 generates additional data samples if necessary (via interpolation). See block 540. Then, the data samples in the selected stream file are stored in the database 408. See block 542. If the answer to the test at decision block 538 is NO, the method 500 proceeds to decision block 544. At decision block 544, it is determined whether the developer wants to look at more stream files. If the answer is NO, the method 500 continues to another continuation terminal (“terminal A6”). Otherwise, the answer is YES and the method 500 proceeds to another continuation terminal (“terminal A4”) where the method 500 loops back to block 532 and begins the above-described steps again.

From terminal A6 (FIG. 5F), the method 500 proceeds to block 546 where the aggregator 406 creates the database 408, which contains data samples and the corresponding actions stored in tables, such as tables 495, 487. The method 500 then enters the exit terminal B. From terminal B (FIG. 5A), the method 500 proceeds to a set of method steps 504 defined between a continuation terminal (“terminal C”) and an exit terminal (“terminal D”). The set of method steps 504 describes the creation of the model 412 for educing an intention of a user using movements of the mouse 306.

From terminal C (FIG. 5F), the method 500 proceeds to block 548 where the developer sets modeling parameters and inputs these parameters into the model builder 410. The model builder 410 then extracts data samples as well as the corresponding actions from the database 408 and generates the model 412. See block 550. The model builder 410 generates an error index or any suitable statistical error measurement for the created model 412 so as to determine its empathetic degree or its eduction accuracy from input data samples to actions. See block 552. Next, the method 500 proceeds to another continuation terminal (“terminal C1”).

From terminal Cl (FIG. 5G), the method 500 proceeds to decision block 554 where a test is made to determine whether the level of empathetic degree or accuracy in the eduction in the empathetic interface 414 is acceptable. If the answer is YES, the method 500 places the model 412 in the empathetic interface 414 as a personal model 414B. See block 556. The empathetic interface can be coupled to the operating system running the personal computer 304 of the user 302 so as to aid the user 302 in navigating the user interface. See block 558. The trainer 416 is optionally coupled to the empathetic interface 414 and is also placed inside the operating system. See block 560. The method 500 then proceeds to the exit terminal D.

If the answer to the test at decision block 554 is NO, the method 500 proceeds to another decision block where a test is made to determine whether there is enough data in the selected stream files (stored in the database 408) for rebuilding the model 412 because its empathetic degree was not acceptable. See decision block 562. If the answer is NO, the method 500 loops back to terminal A where the above-described process steps are repeated. If the answer is YES to the test at decision block 562, the method 500 proceeds to terminal A4 where the above-described processing steps with aggregating stream files are once again repeated.

From terminal D (FIG. 5A), the method 500 proceeds to a set of method steps 506, defined between a continuation terminal (“terminal E”) and an exit terminal (“terminal F”). The set of method steps 506 describes educing the user's 302 intentions using the empathetic interface 414, which contains the model 412, to aid the user 302 in his navigation of the pointer 322 via the mouse 306.

From terminal E (FIG. 5H), the method 500 proceeds to block 564 where the empathetic interface 414 translates mouse motions and button presses to educe the intention of the user 302 to navigate the pointer 322. The method 500 then proceeds to decision block 566 where a test is made to determine whether the intention was correctly educed. If the answer is YES, the method 500 loops back to block 564 where the empathetic interface 414 continues to aid the user 302 in navigating the pointer 322 via the mouse 306. If the answer to the test at decision block 566 is NO, the trainer 416 retrains the personal model 414B by comparing the predicted action to the actual action taken by the user 302. See block 568. If there are too many errors even after retraining, the method 500 proceeds to the exit terminal F and finishes execution. See decision block 570. If the answer to the test at decision block 570 is NO, the method 500 loops back to terminal E where the above-described processing steps are repeated.

The essence of the embodiments of the present invention is to learn the preferences of the user 302 usage of a pointing device, such as the mouse 306, and then use these preferences later to empathetically educe the intentions of the user using the mouse 306 to better navigate a user interface. Examples include automatically anticipating the pressing of the right mouse button to bring up context menus; supplanting collapsing menus with full menus and moving the pointer to menu items that are likely to be used by the user 302; autoscrolling documents, such as Web pages, at the speed that the user 302 would tend to use; and automatically generating rules for handling e-mail messages, such as file, delete, or reply.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A computer system for educing intentions of a user, comprising:
an on-screen cursor for performing user interface actions in a user interface, the on-screen cursor being controlled by a pointing device; and
an empathetic interface for educing a user's intention to move the on-screen cursor from a first location to a target location in the user interface and moving the on-screen cursor to the target location from the first location when the user initiates actuation of the pointing device to cause the on-screen cursor to begin to move toward the target location.

2. The computer system of claim 1, wherein the on-screen cursor includes an on-screen icon.

3. The computer system of claim 2, wherein the on-screen cursor is selected from a group consisting of a blinking underline, a blinking rectangle, a blinking vertical bar, and an arrowhead leaning slightly leftward or rightward.

4. The computer system of claim 1, wherein the pointing device is selected from a group consisting of a mouse, a graphics tablet, a stylus, a light pen, a joystick, a puck, and a trackball.

5. The computer system of claim 1, wherein the empathetic interface receives information pertaining to the actuation of the pointing device and produces the target location to which the user intends to move the on-screen cursor.

6. A computer system for building an empathetic interface to educe a user's intentions to navigate an on-screen cursor in a user interface, the computer system comprising:
a model builder adapted for receiving events generated by a pointing device when the user navigates the on-screen cursor toward a user interface target to perform an action, the model builder being further adapted for receiving model parameters; and
a model for empathetically educing a user's intention to navigate the on-screen cursor toward the user interface target to perform the action, the model being built by the model builder in accordance with the received events and the model parameters.

7. The computer system of claim 6, wherein the pointing device includes a mouse.

8. The computer system of claim 7, further comprising a mouse information gatherer for gathering mouse, keyboard, and timing information to produce stream files with which to build the empathetic interface.

9. The computer system of claim 8, wherein the mouse information gatherer includes a mouse data hook for collecting events generated by the actuations of the mouse.

10. The computer system of claim 9, wherein the mouse information gatherer includes a keyboard data hook for collecting events generated by keyboard key presses.

11. The computer system of claim 10, wherein the mouse information gatherer includes a timer for generating time-out events to indicate inactivity after the pointer is moved but no action is performed.

12. The computer system of claim 11, wherein the mouse information gatherer includes a movement detector that extracts the Cartesian coordinates x, y, and the absolute time from an event received from the mouse data hook.

13. The computer system of claim 12, wherein the mouse information gatherer includes a button detector that extracts from the event a button on the mouse that was pressed and the state of the depressed button.

14. The computer system of claim 13, wherein the mouse information gatherer includes a decimator for reducing the number of data samples comprising the events.

15. The computer system of claim 14, wherein the mouse information gatherer includes a collector for moving stream files to a storage location so as to prevent taxing a computing system on which the mouse information gatherer is executed.

16. The computer system of claim 6, further comprising an aggregator for presenting a stream file to a developer for selecting the contents of the stream file for building the model.

17. The computer system of claim 16, further comprising a database for storing the contents of the selected stream file.

18. The computer system of claim 6, further comprising the empathetic interface that incorporates the model so as to educe the user's intentions.

19. The computer system of claim 18, further comprising a trainer to retrain the model when the eduction of the model is not sufficiently accurate.

20. A computer-readable medium having a data structure stored thereon for use by a computing system to educe user intentions, the data structure comprising:
a header field that is indicative of a screen resolution and a screen origin; and
a data field that is indicative of a start event, a move event, and a termination event of a pointing device being actuated by a user in navigating an on-screen cursor in a user interface.

21. The data structure of claim 20, wherein nesting within the header field is a screen resolution field that indicates a width and a height of a screen.

22. The data structure of claim 20, wherein nesting within the header field is a screen origin field that indicates Cartesian coordinates of the origin of a screen to facilitate normalization.

23. The data structure of claim 20, wherein nesting within the data field is a start event field, which indicates the beginning of a new pointing device action, and wherein nesting within the data field are fields for storing Cartesian coordinates x, y, which define the location of the pointing device, and an absolute time.

24. The data structure of claim 20, wherein nesting within the data field is a window event field, which includes a window class field and an application type field for distinguishing one event from another event.

25. The data structure of claim 20, wherein nesting within the data field is a move event field, which includes fields for storing Cartesian coordinates x, y, and a relative time, for indicating a move event.

26. The data structure of claim 20, wherein nesting within the data field is a termination event field, which includes fields for storing Cartesian coordinates x, y, and a relative time, for indicating a termination event.

27. The data structure of claim 20, wherein nesting within the data field is another window event field, which includes fields for storing a window class and an application type in which the on-screen cursor ends up.

28. The data structure of claim 20, wherein the header allows normalization of negative coordinates so as enable referencing every location of any screen to Cartesian coordinates 0, 0.

29. The data structure of claim 20, wherein the header allows normalization of pointing device information gathered from different users with different screen resolutions.

30. A computer system for educing intentions of a user, comprising:
an operating system that controls usage of resources in the computer system; and
an empathetic interface coupled to the operating system for educing a user's intention to move an on-screen cursor from a first location to a target location in a user interface to perform an action and moving the on-screen cursor to the target location from the first location to perform the action when the user initiates actuation of a pointing device to cause the on-screen cursor to begin to move toward the target location.

31. The computer system of claim 30, wherein the empathetic interface includes a personal gatherer for gathering mouse, keyboard, and timer information.

32. The computer system of claim 30, wherein the empathetic interface includes a personal model that can educe the user's intention to move the on-screen cursor to the target location to perform the action.

33. The computer system of claim 30, further comprising a trainer for retraining the empathetic interface when its eduction is not sufficiently accurate.

34. The system of claim 33, wherein the trainer includes a trainer model, which can educe a user's intention, and a trainer gatherer, which gathers both actual actions and predicted actions for comparison.

35. A method implemented in a computer system for educing a user's intention for navigating a pointer in a user interface, the method comprising:
inputting a set of Cartesian coordinates, which are indicative of a first location of the pointer when the user initiates the actuation of a pointing device toward a target location, the act of inputting including inputting a velocity of the actuation into a model; and
empathetically educing the target location including an action to be taken by the pointer when the pointer has been moved by the method to the target location.

36. The method of claim 35, wherein the act of inputting includes inputting data selected from a group consisting of changes in the Cartesian coordinates, changes in the vertical acceleration of the actuation of the pointing device, changes in the horizontal acceleration of the actuation of the pointing device, a size of the screen, and an acceleration of the actuation of the pointing device.

37. The method of claim 35, wherein the act of educing includes educing an action that causes a button state of a pointing device to be up or down.

38. The method of claim 35, wherein the act of educing includes educing an action that causes the pointer to move to a menu item in a menu that is likely to be used by the user.

39. The method of claim 35, wherein the act of educing includes educing an action that causes scrolling of a document at a speed desired by the user.

40. A computer-readable medium having computer-executable instructions for educing a user's intention for navigating a pointer in a user interface, the method comprising:
inputting a set of Cartesian coordinates, which are indicative of a first location of the pointer when the user initiates the actuation of a pointing device toward a target location, the act of inputting including inputting a velocity of the actuation into a model; and
empathetically educing the target location including an action to be taken by the pointer when the pointer has been moved by the method to the target location.

41. The computer-readable medium of claim 40, wherein the act of inputting includes inputting data selected from a group consisting of changes in the Cartesian coordinates, changes in the vertical acceleration of the actuation of the pointing device, changes in the horizontal acceleration of the actuation of the pointing device, a size of the screen, and an acceleration of the actuation of the pointing device.

42. The computer-readable medium of claim 40, wherein the act of educing includes educing an action that causes a button state of a pointing device to be up or down.

43. The computer-readable medium of claim 40, wherein the act of educing includes educing an action that causes the pointer to move to a menu item in a menu that is likely to be used by the user.

44. The computer-readable medium of claim 40, wherein the act of educing includes educing an action that causes the scrolling of a document at a speed desired by the user.

45. A method implementable in a computer system for building an empathetic interface that educes user intentions for navigating a pointer, the method comprising:
accumulating data relating to a pointing device;
building a model for educing user intentions using the accumulated data;
educing the user's intention to navigate the pointer from a first location of the pointer to perform an action at a target location when the user initiates the actuation of a pointing device toward the target location; and
retraining the model if the model is not sufficiently accurate.

46. A computer-readable medium having computer-executable instructions for building an empathetic interface that educes user intentions for navigating a pointer, the method comprising:
accumulating data relating to a pointing device;
building a model for educing user intentions using the accumulated data;
educing the user's intention to navigate the pointer from a first location of the pointer to perform an action at a target location when the user initiates the actuation of a pointing device toward the target location; and
retraining the model if the model is not sufficiently accurate.
